(19) United States
(12) Patent Application Publication
(10) Pub. No.: US 2022/0398200 A1
(43) Pub. Date: Dec. 15, 2022

(54) MEMORY PROTOCOL WITH PROGRAMMABLE BUFFER AND CACHE SIZE

(71) Applicant: Micron Technology, Inc., Boise, ID (US)

(72) Inventor: Robert M. Walker, Raleigh, NC (US)

(21) Appl. No.: 17/893,129

(22) Filed: Aug. 22, 2022

Related U.S. Application Data
(63) Continuation of application No. 15/484,793, filed on Apr. 11, 2017.

(51) Int. Cl. G06F 12/0893; G06F 12/02

(52) U.S. Cl. CPC G06F 12/0893; G06F 12/0238; G06F 2212/1004; G06F 2212/7203; G06F 2212/222; G06F 2212/601

(57) ABSTRACT

The present disclosure includes apparatuses and methods related to a memory protocol with programmable buffer and cache size. An example apparatus can program a resister to define a size of a buffer in memory, store data in the buffer in a first portion of the memory defined by the register, and store data in a cache in a second portion of the memory.

### PRIORITY INFORMATION

This application is a Continuation of U.S. application Ser. No. 15/484,793, filed on Apr. 11, 2017, the contents of which are incorporated herein by reference.

### TECHNICAL FIELD

The present disclosure relates generally to memory devices, and more particularly, to apparatuses and methods for a memory protocol with programmable buffer and cache size.

### BACKGROUND

Memory devices are typically provided as internal, semiconductor, integrated circuits in computers or other electronic devices. There are many different types of memory including volatile and non-volatile memory. Volatile memory can require power to maintain its data and includes random-access memory (RAM), dynamic random access memory (DRAM), and synchronous dynamic random access memory (SDRAM), among others. Non-volatile memory can provide persistent data by retaining stored data when not powered and can include NAND flash memory, NOR flash memory, read only memory (ROM), Electrically Erasable Programmable ROM (EEPROM), Erasable Programmable ROM (EPROM), and resistance variable memory such as phase change random access memory (PCRAM), resistive random access memory (RRAM), and magnetoresistive random access memory (MRAM), among others.

Memory is also utilized as volatile and non-volatile data storage for a wide range of electronic applications. Non-volatile memory may be used in, for example, personal computers, portable memory sticks, digital cameras, cellular telephones, portable music players such as MP3 players, movie players, and other electronic devices. Memory cells can be arranged into arrays, with the arrays being used in memory devices.

Memory can be part of a memory module (e.g., a dual in-line memory module (DIMM)) used in computing devices. Memory modules can include volatile, such as DRAM, for example, and/or non-volatile memory, such as Flash memory or RRAM, for example. The DIMMs can be using a main memory in computing systems.

### BRIEF DESCRIPTION OF THE DRAWINGS

FIG. 1A is a block diagram of an apparatus in the form of a computing system including a memory system in accordance with a number of embodiments of the present disclosure.

FIGS. 1B-1D are block diagrams of an apparatus in the form of a dual in-line memory modules (DIMM) in accordance with a number of embodiments of the present disclosure.

FIGS. 2A-2B are diagrams of a buffer/cache in accordance with a number of embodiments of the present disclosure.

FIG. 3 is a diagram of a number of registers in accordance with a number of embodiments of the present disclosure.

### DETAILED DESCRIPTION

The present disclosure includes apparatuses and methods related to a memory protocol with programmable buffer and cache size. An example apparatus can program a register to define a size of a buffer in memory, store data in the buffer in a first portion of the memory defined by the register, and store data in a cache in a second portion of the memory.

In a number of embodiments, a portion of memory can be implemented as buffer/cache for a non-volatile dual in-line memory module (NVDIMM) device. The memory that is implemented as buffer/cache can be on the controller and/or can be in a memory device coupled to the controller. The memory devices of the NVDIMM device can include a volatile memory array (e.g., DRAM) and/or a non-volatile memory array (e.g., NAND Flash). The memory on the controller implemented as the buffer/cache can be SRAM, for example The memory implemented as the buffer/cache in a memory device can be a DRAM memory array, for example. A portion of SRAM can be a buffer/cache for a DRAM memory array and/or a non-volatile memory array, and a portion of DRAM can be a buffer/cache or a non-volatile memory array.

The buffer/cache can include a portion that is used as a buffer for the NVDIMM device and a portion that is used as cache for the NVDIMM device. The size of the portion of the memory that is used a buffer can be defined by a register. The size of the portion of the memory that is used as cache can also be defined by the register and/or be remaining portion of the memory that is not used as the buffer. The register can be programmed by the host. The register can also be programmed by the NVDIMM controller. A register can also be programmed to define the memory density that is being used for the buffer/cache. The register that defines the memory density can be used to determine the total size of the buffer/cache.

The portion of the buffer/cache that is used as buffer can be configured to store signals, address signals (e.g., read and/or write commands), and/or data (e.g., write data). The buffer can temporarily store signals and/or data while commands are executed. The portion of the buffer/cache that is used a cache can be configured to store data that is also stored in a memory device. The data stored in cache and in the memory device is addressed by the controller and can located in cache and/or the memory device during execution of a command.

In a number of embodiments, the size of the portion of the memory implemented as a buffer and the size of the portion of memory implemented as cache can be based on how the NVDIMM device is being used. For example, if the NVDIMM device is executing more commands that use a buffer, then the size of the buffer can be larger than the cache. If there are changes to how NVDIMM device is being used, then the relative size of the buffer and cache can be modified by programming a register to reflect that change. For example, if the host is performing more block/write operations that use a buffer than memory load/store (e.g., read) operations that use cache, then the buffer can be configured to be larger in size than the cache. Once the host device has written data to the memory arrays of the NVDIMM device, it may receive more read commands to access the data, which will use the cache. The size of the cache can then be increased by reprogramming the register so that the cache can be configured to be larger in size than the buffer.

In the following detailed description of the present disclosure, reference is made to the accompanying drawings that form a part hereof, and in which is shown by way of illustration how a number of embodiments of the disclosure may be practiced. These embodiments are described in sufficient detail to enable those of ordinary skill in the art to practice the embodiments of this disclosure, and it is to be understood that other embodiments may be utilized and that process, electrical, and/or structural changes may be made without departing from the scope of the present disclosure. As used herein, the designator “N” indicates that a number of the particular feature so designated can be included with a number of embodiments of the present disclosure.

As used herein, “a number of” something can refer to one or more of such things. For example, a number of memory devices can refer to one or more of memory devices. Additionally, designators such as “N”, as used herein, particularly with respect to reference numerals in the drawings, indicates that a number of the particular feature so designated can be included with a number of embodiments of the present disclosure.

The figures herein follow a numbering convention in which the first digit or digits correspond to the drawing figure number and the remaining digits identify an element or component in the drawing. Similar elements or components between different figures may be identified by the use of similar digits. As will be appreciated, elements shown in the various embodiments herein can be added, exchanged, and/or eliminated so as to provide a number of additional embodiments of the present disclosure. In addition, the proportion and the relative scale of the elements provided in the figures are intended to illustrate various embodiments of the present disclosure and are not to be used in a limiting sense.

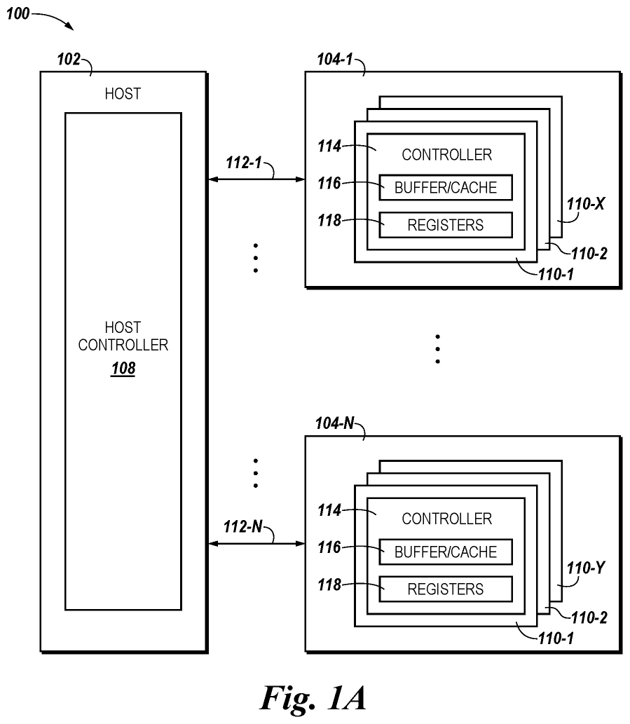

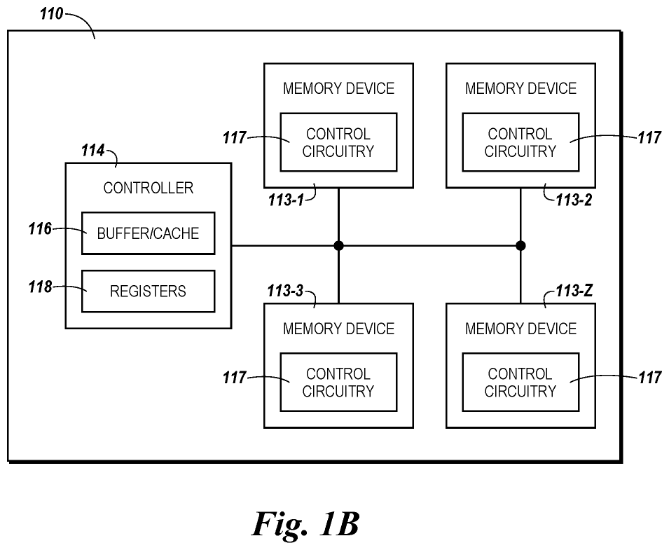

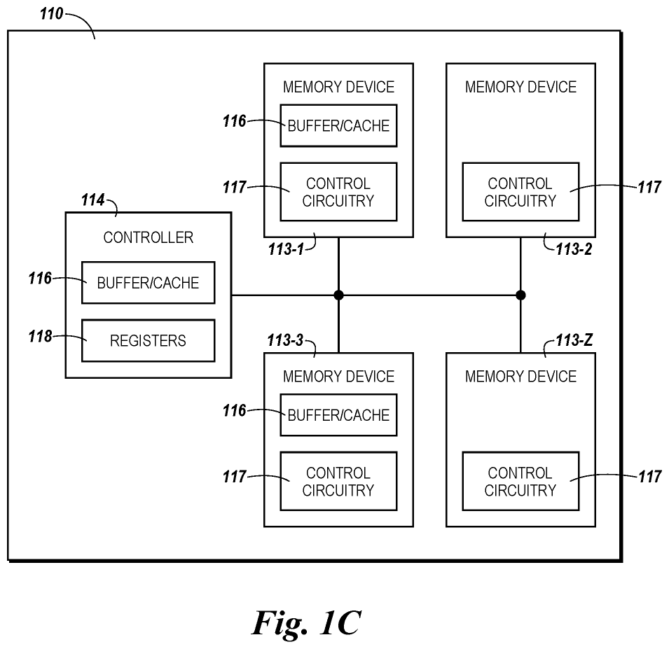

FIG. 1A is a functional block diagram of a computing system 100 including an apparatus in the form of a number of memory systems 104-1 . . . 104-N, in accordance with one or more embodiments of the present disclosure. As used herein, an “apparatus” can refer to, but is not limited to, any of a variety of structures or combinations of structures, such as a circuit or circuitry, a die or dice, a module or modules, a device or devices, or a system or systems, for example. In the embodiment illustrated in FIG. 1A, memory systems 104-1 . . . 104-N can include a one or more modules, such as dual in-line memory modules (DIMM) 110-1, . . . , 110-X, 110-Y. The DIMMs 110-1, . . . , 110-X, 110-Y can include volatile memory and/or non-volatile memory. In a number of embodiments, memory systems 104-1, . . . , 104-N can include a multi-chip device. A multi-chip device can include a number of different memory types and/or memory modules. For example, a memory system can include a number of chips having non-volatile or volatile memory on any type of a module. The examples described below in association with FIGS. 1A-3 use a DIMM as the memory module, but the protocol of the present disclosure can be used on any memory system where memory can execute non-deterministic commands. In FIG. 1A, memory system 104-1 is coupled to the host via channel 112-1 can include DIMMs 110-1, . . . , 110-X, where DIMM 110-1 is a NVDIMM and 110-X is DRAM DIMM. In this example, each DIMM 110-1, . . . , 110-X, 110-Y includes a controller 114. Controller 114 can receive commands from host 102 and control execution of the commands on a DIMM. Also, in a number of embodiments, the protocol of the present disclosure could be implemented by a memory device (e.g., a DIMM) without a controller and execution of the commands using the protocol of the present disclosure could be built into the memory device. The host 102 can send commands to the DIMMs 110-1, . . . , 110-X, 110-Y using the protocol of the present disclosure and/or a prior protocol, depending on the type of memory in the DIMM. For example, the host can use the protocol of the present disclosure to communicate on the same channel (e.g., channel 112-1) with a NVDIMM and a prior protocol to communicate with a DRAM DIMM that are both on the same memory system. The host and the NVDIMM can communicate via read ready (R_RDY) signals, read send (R_SEND) signals, write credit increment (WC_INC) signals, and read identification (RID) signals according the protocol of the present disclosure. The read ready (R_RDY) signals, read send (R_SEND) signals, write credit increment (WC_INC) signals, and read identification (RID) signals can be sent via pins that are unused in a prior protocol (e.g. DDR4) or are pins from a prior protocol (e.g. DDR4) that are repurposed (e.g. used differently) so that the present protocol is compatible with the prior protocol. Also, pins can be assigned to the read ready (R_RDY) signals, read send (R_SEND) signals, write credit increment (WC_INC) signals, and read identification (RID) signals in protocols that are being developed (e.g., DDR5).

As illustrated in FIG. 1A, a host 102 can be coupled to the memory systems 104-1 . . . 104-N. In a number of embodiments, each memory system 104-1 . . . 104-N can be coupled to host 102 via a channel. In FIG. 1A, memory system 104-1 is coupled to host 102 via channel 112-1 and memory system 104-N is coupled to host 102 via channel 112-N. Host 102 can be a laptop computer, personal computers, digital camera, digital recording and playback device, mobile telephone, PDA, memory card reader, interface hub, among other host systems, and can include a memory access device, e.g., a processor. One of ordinary skill in the art will appreciate that “a processor” can intend one or more processors, such as a parallel processing system, a number of coprocessors, etc.

Host 102 includes a host controller 108 to communicate with memory systems 104-1 . . . 104-N. The host controller 108 can send commands to the DIMMs 110-1, . . . , 110-X, 110-Y via channels 112-1 . . . 112-N. The host controller 108 can communicate with the DIMMs 110-1, . . . , 110-X, 110-Y and/or the controller 114 on each of the DIMMs 110-1, . . . , 110-X, 110-Y to read, write, and erase data, among other operations. A physical host interface can provide an interface for passing control, address, data, and other signals between the memory systems 104-1 . . . 104-N and host 102 having compatible receptors for the physical host interface. The signals can be communicated between 102 and DIMMs 110-1, . . . , 110-X, 110-Y on a number of buses, such as a data bus and/or an address bus, for example, via channels 112-1 . . . 112-N.

The host controller 108 and/or controller 114 on a DIMM can include control circuitry, e.g., hardware, firmware, and/or software. In one or more embodiments, the host controller 108 and/or controller 114 can be an application specific integrated circuit (ASIC) coupled to a printed circuit board including a physical interface. Also, each DIMM 110-1, . . . , 110-X, 110-Y can include buffer/cache 116 of volatile and/or non-volatile memory and registers 118. Buffer/cache 116 can be used to buffer and/or cache data that is used during execution of read commands and/or write commands. The buffer/cache 116 can be split into a first portion that can be a buffer and a second portion that can be a cache. The amount of space (e.g., size) that is dedicated to the buffer and/or the amount of space dedicated to the cache can be controlled by the host controller 108 via registers 118. The host can control the amount of space in the buffer/cache 116 dedicated to the buffer and/or the cache based on the density of the memory in the DIMM, the number of desired entries in the buffer, and/or the type of commands that are being sent to a particular DIMM. In a number of embodiments, the DIMM can have a fixed buffer size and/or a fixed cache size. Registers 118 can be programmed with media density information and/or buffer size information that is used to determine the size of the buffer and the size of the cache.

The portion of the buffer/cache 116 that is used as buffer can be configured to store signals, address signals (e.g., read and/or write commands), and/or data (e.g., write data). The buffer can temporarily store signals and/or data while commands are executed. The portion of the buffer/cache 116 that is used a cache can be configured to store data that is also stored in a memory device. The data stored in cache and in the memory device is addressed by the controller and can located in cache and/or the memory device during execution of a command.

The DIMMs 110-1, . . . , 110-X, 110-Y can provide main memory for the memory system or could be used as additional memory or storage throughout the memory system. Each DIMM 110-1, . . . , 110-X, 110-Y can include one or more arrays of memory cells, e.g., non-volatile memory cells. The arrays can be flash arrays with a NAND architecture, for example. Embodiments are not limited to a particular type of memory device. For instance, the memory device can include RAM, ROM, DRAM, SDRAM, PCRAM, RRAM, and flash memory, among others.

The embodiment of FIG. 1A can include additional circuitry that is not illustrated so as not to obscure embodiments of the present disclosure. For example, the memory systems 104-1 . . . 104-N can include address circuitry to latch address signals provided over I/O connections through I/O circuitry. Address signals can be received and decoded by a row decoder and a column decoder to access the DIMMs 110-1, . . . , 110-X, 110-Y. It will be appreciated by those skilled in the art that the number of address input connections can depend on the density and architecture of the DIMMs 110-1, . . . , 110-X, 110-Y.

FIGS. 1B-1D are block diagrams of an apparatus in the form of a dual in-line memory modules (DIMM) in accordance with a number of embodiments of the present disclosure. FIG. 1B is a block diagram of an apparatus in the form of a dual in-line memory modules (DIMM) 110 in accordance with a number of embodiments of the present disclosure. In FIG. 1B, DIMM 110 can include a controller 114. Controller 114 can include memory, such as SRAM memory, that can be a buffer/cache 116 and/or a number of registers 118. DIMM 110 can include a number of memory devices 113-1, . . . , 113-Z coupled to the controller. Memory devices 113-1, . . . , 113-Z can include non-volatile memory arrays and/or volatile memory arrays.

Memory devices 113-1, . . . , 113-Z can include control circuitry 117 (e.g., hardware, firmware, and/or software) which can be used to execute commands on the memory devices 113-1, . . . , 113-Z. The control circuitry 117 can receive commands from controller 114. The control circuitry 117 can be configured to execute commands to read and/or write data in the memory devices 113-1, . . . , 113-Z.

The buffer/cache 116 can include a portion that is used as a buffer for the NVDIMM device 110 and a portion that is used as cache for the NVDIMM device 110. The size of the portion of the memory that is used a buffer can be defined by register 118. The size of the portion of the memory that is used as cache can also be defined by the registers 118 and/or be the remaining portion of the memory that is not used as the buffer. Registers 118 can also be programmed to define the memory density that is being used for the buffer/cache 116. Registers 118 that define the memory density can be used to determine the total size of the buffer/cache 116.

FIG. 1C is a block diagram of an apparatus in the form of a dual in-line memory modules (DIMM) 110 in accordance with a number of embodiments of the present disclosure. In FIG. 1C, DIMM 110 can include a controller 114. Controller 114 can include memory, such as SRAM memory, that can be a buffer/cache 116 and/or a number of registers 118. DIMM 110 can include a number of memory devices 113-1, . . . , 113-Z coupled to the controller. Memory devices 113-1, . . . , 113-Z can include non-volatile memory arrays and/or volatile memory arrays. Memory device 113-1, . . . , 113-3 that include volatile memory, such as DRAM, can be used as a buffer/cache 116. Memory devices 113-1, . . . , 113-Z can include control circuitry 117 (e.g., hardware, firmware, and/or software) which can be used to execute commands on the memory devices 113-1, . . . , 113-Z. The control circuitry 117 can receive commands from controller 114. The control circuitry 117 can be configured to execute commands to read and/or write data in the memory devices 113-1, . . . , 113-Z. In a number of embodiments, where the buffer/cache 116 is located in a memory device 113-1, . . . , 113-3, the buffer/cache 116 can be used as a buffer/cache for commands that are directed to memory devices memory devices 113-1, . . . , 113-Z. In a number of embodiments, where the buffer/cache 116 is located in a memory device 113-1, . . . , 113-3, the buffer/cache 116 can be used as a buffer/cache for commands that are directed to memory devices memory devices 113-1, . . . , 113-Z. For example, a command directed toward memory device 113-Z can be executed using the buffer/cache 116 on memory device 113-1. The command can be executed without using the buffer/cache 116 on controller 114, for example. Also, data that is stored in memory device 113-Z can also be cached in buffer/cache 116 on memory device 113-1. Therefore, when data stored in memory device 113-Z that is cached on buffer cache 116 on memory device 113-1 is access via a read operation, the read operation can be executed by obtaining the data from cache 116 on memory device 113-1 and a read operation is not performed on memory device 113-Z.

The buffer/cache 116 can include a portion that is used as a buffer for the NVDIMM device 110 and a portion that is used as cache for the NVDIMM device 110. The size of the portion of the memory that is used a buffer can be defined by register 118. The size of the portion of the memory that is used as cache can also be defined by the registers 118 and/or be the remaining portion of the memory that is not used as the buffer. Registers 118 can also be programmed to define the memory density that is being used for the buffer/cache 116. Registers 118 that define the memory density can be used to determine the total size of the buffer/cache 116.

FIG. 1D is a block diagram of an apparatus in the form of a dual in-line memory modules (DIMM) 110 in accordance with a number of embodiments of the present disclosure. In FIG. 1D, DIMM 110 can include a controller 114. Controller 114 can include memory, such as SRAM memory, that can be a buffer/cache 116 and/or a number of registers 118. DIMM 110 can include a number of memory devices 113-1, . . . , 113-Z coupled to the controller. Memory devices 113-1, . . . , 113-Z can include non-volatile memory arrays and/or volatile memory arrays. Memory device 113-1, . . . , 113-Z that include volatile memory, such as DRAM, can be used as a buffer/cache 116. Memory devices 113-1, . . . , 113-Z can include control circuitry 117 (e.g., hardware, firmware, and/or software) which can be used to execute commands on the memory devices 113-1, . . . , 113-Z. The control circuitry 117 can receive commands from controller 114. The control circuitry 117 can be configured to execute commands to read and/or write data in the memory devices 113-1, . . . , 113-Z. In a number of embodiments, where the buffer/cache 116 is located in a memory device 113-1, . . . , 113-Z, the buffer/cache 116 can be used as a buffer/cache for commands that are directed to memory devices memory devices 113-1, . . . , 113-Z. For example, a command directed toward memory device 113-Z can be executed using the buffer/cache 116 on memory device 113-1. The command can be executed without using the buffer/cache 116 on controller 114, for example. Also, data that is stored in memory device 113-Z can also be cached in buffer/cache 116 on memory device 113-1. Therefore, when data stored in memory device 113-Z that is cached on buffer cache 116 on memory device 113-1 is access via a read operation, the read operation can be executed by obtaining the data from cache 116 on memory device 113-1 and a read operation is not performed on memory device 113-Z.

The buffer/cache 116 can include a portion that is used as a buffer for the NVDIMM device 110 and a portion that is used as cache for the NVDIMM device 110. The size of the portion of the memory that is used a buffer can be defined by register 118. The size of the portion of the memory that is used as cache can also be defined by the registers 118 and/or be the remaining portion of the memory that is not used as the buffer. Registers 118 can also be programmed to define the memory density that is being used for the buffer/cache 116. Registers 118 that define the memory density can be used to determine the total size of the buffer/cache 116.

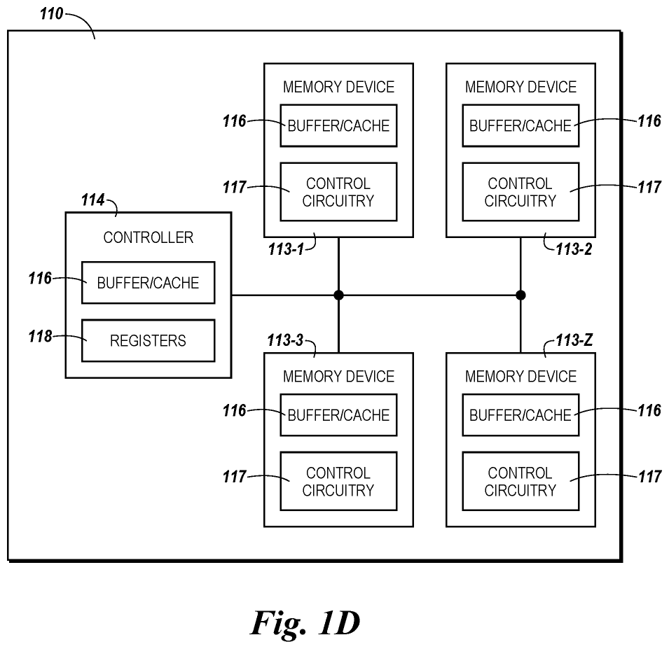

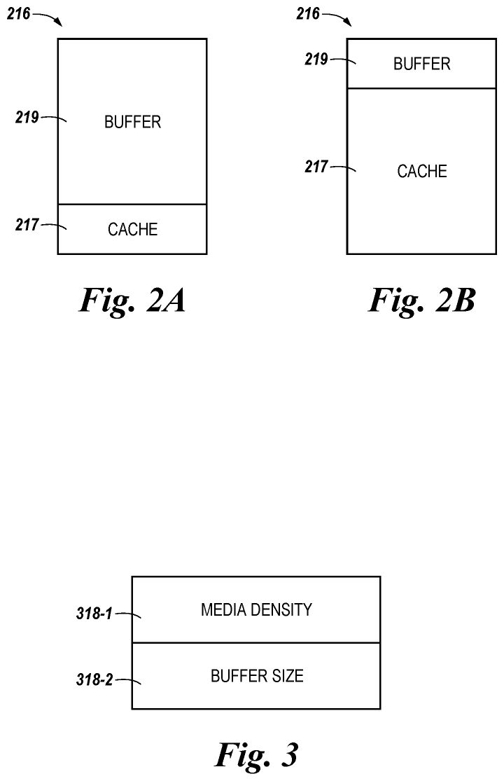

FIGS. 2A-2B are diagrams of a buffer/cache in accordance with a number of embodiments of the present disclosure. FIGS. 2A-2B illustrate a memory configured as a buffer and a cache in accordance with a number of embodiments of the present disclosure. In FIG. 2A, cache/buffer 216 is configured with a first portion as a buffer 219 and a second portion as a cache 217. In FIG. 2A, buffer 219 is larger in size than cache 217. Buffer 219 can be larger than cache 217 when a DIMM is receiving more commands that use a buffer when executing the commands, such as write commands, block based commands, and/or direct memory access (DMA) data movement, for example.

In a number of embodiments, the size of the portion of the memory implemented as a buffer 219 and the size of the portion of memory implemented as cache 217 can be based on the relative quantities commands being issued by the host that use a buffer 219 and/or a cache 217. The relative quantities of commands issued by the host that use a buffer 219 and/or a cache 217 can be dependent on the application being run by the host. For example, if the NVDIMM device is executing more commands that use a buffer 219, then registers can be programmed so the size of the buffer 219 can be larger than the cache 217. If the NVDIMM device is performing operations that use cache 217 more than buffer 219, then registers can be programmed so the size of the cache is larger than the size of the buffer. The register can be programmed to change the size of the buffer in response to the buffer being at a threshold capacity, such as full, for example, and the cache being at least partially empty. The register can be programmed to change the size of the buffer in response to the cache being at a threshold capacity, such as full, for example, and the buffer being at least partially empty. The size of the cache 217 and/or buffer 219 can be changed as the host changes the applications that are running.

The size of the buffer 219 defined by registers can be based on the block size of the non-volatile memory arrays of the NVDIMM device. If the host and/or controller want to be able to store a particular number of entries (e.g., a threshold number of entries) that are the size of the block size of the non-volatile memory arrays 113, then the size of the buffer 219 is based on the particular number of desired entries multiplied by the block size of the non-volatile memory arrays of the NVDIMM device.

In a number of embodiments, a register can be programmed by the host (e.g., host 102 in FIG. 1A) and/or by a DIMM controller (e.g., controller 114 in FIG. 1A) to define the size of the buffer 119 and/or cache 117. For example, if a buffer/cache 216 includes 16 MB of memory, the register may be programmed to define the buffer 119 as 85% of the memory and cache 117 as the remaining portion of the memory. Therefore, buffer 119 would include 13.6 MB of memory and cache 117 would include 2.4 MB of memory.

In FIG. 2B, cache/buffer 216 is configured with a first portion as a buffer 219 and a second portion as a cache 217. In FIG. 2B, buffer 219 is smaller in size than cache 217. Buffer 219 can be smaller than cache 217 when a DIMM is receiving more commands that use a cache when executing the commands, such as read commands and/or applications with spatial locality, for example.

In a number of embodiments, a register can be programmed by the host (e.g., host 102 in FIG. 1A) and/or by a DIMM controller (e.g., controller 114 in FIG. 1A) to define the size of the buffer 119 and/or cache 117. For example, if a buffer/cache 216 includes 10 MB of memory, the register may be programmed to define the buffer 119 as 10% of the memory and cache 117 as the remaining portion of the memory. Therefore, buffer 119 would include 1 MB of memory and cache 117 would include 9 MB of memory.

FIGS. 3 is a diagram of a number of registers in accordance with a number of embodiments of the present disclosure. FIG. 3 includes register 318-1 that can define the media density. The media density can include the storage capacity of memory that will used as the buffer/cache. In FIG. 3, register 318-2 can define the size of the buffer. Register 318-2 can define the size of the buffer by indicating a percentage of the memory that will be implemented at a buffer. Register 318-2 can also define the size of the buffer by indicated the storage capacity for the buffer (e.g., 3 MB, for example). Register 318-2 can also define the size of the cache, either explicitly by indicating a percentage of memory and/or storage capacity for the cache. The size of the cache can also be implicitly be defined by register 318-2 by implementing the remaining portion not used as the buffer for the cache. Register 318-2 can allow a DIMM to support a number of applications. Register 318-2 can be configured define the size of the buffer and/or cache to support a number of applications based upon their need to have a buffer and/or cache of particular sizes.

Although specific embodiments have been illustrated and described herein, those of ordinary skill in the art will appreciate that an arrangement calculated to achieve the same results can be substituted for the specific embodiments shown. This disclosure is intended to cover adaptations or variations of various embodiments of the present disclosure. It is to be understood that the above description has been made in an illustrative fashion, and not a restrictive one. Combination of the above embodiments, and other embodiments not specifically described herein will be apparent to those of skill in the art upon reviewing the above description. The scope of the various embodiments of the present disclosure includes other applications in which the above structures and methods are used. Therefore, the scope of various embodiments of the present disclosure should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. An apparatus, comprising:
a memory device; and
a memory controller coupled to the memory device, wherein the memory controller comprises a buffer/cache, a first register, and a second register, and
wherein the controller is configured to:
program the first register to define a media density including a storage capacity of the buffer/cache; and
program the second register to define a size of a buffer portion of the buffer/cache.

2. The apparatus of claim 1, wherein the memory device includes at least one of a volatile memory array or a non-volatile memory array.

3. The apparatus of claim 2, wherein the volatile memory array is a dynamic random access memory (DRAM) array, the non-volatile memory array is a NAND Flash array, and the buffer/cache is static random access memory (SRAM) array.

4. The apparatus of claim 1, wherein the buffer portion of the buffer/cache is configured to store at least one of signals or data while commands are executed.

5. The apparatus of claim 1, wherein a cache portion of the buffer/cache is configured to store data located in the cache portion and the memory device during execution of a command.

6. A system, comprising:
a number of memory devices; and
a memory controller coupled to the number of memory devices, wherein the memory controller comprises:
a buffer/cache;
a first register configured to define a media density including a storage capacity of
the buffer/cache; and
a second register configured to define a size of a cache portion of the buffer/cache.

7. The system of claim 6, wherein each of the number of memory devices include control circuitry configured to:
receive commands from the memory controller; and
execute the commands.

8. The system of claim 7, wherein executing the commands includes at least one of reading data or writing data.

9. The system of claim 6, wherein a first memory device of the number of memory devices comprises a different buffer/cache.

10. The system of claim 9, wherein the different buffer/cache is a dynamic random access memory (DRAM).

11. The system of claim 9, wherein the different buffer/cache is configured to execute a first command directed towards a second memory device of the number of memory devices.

12. The system of claim 11, wherein the different buffer/cache is configured to execute the first command without using the buffer/cache of the memory controller.

13. The system of claim 11, wherein the second memory device is configured to store a first portion of data; and
wherein the different buffer/cache is configured to cache the first portion of data.

14. A method, comprising:
programming a first register of a memory controller to define a media density including a storage capacity of a buffer/cache of the memory controller;
programming a second register of the memory controller to define a size of a buffer portion of the buffer/cache of the memory controller, wherein a size of the cache portion of the buffer/cache is based on an amount of memory remaining that is not used as the buffer portion;
executing a number of commands; and
reprogramming the second register of the memory controller to redefine the size of the
buffer portion of the buffer/cache of the memory controller based at least in part on the number of commands.

15. The method of claim 14, wherein the number of commands use the buffer portion more than the cache portion.

16. The method of claim 15, further comprising reprogramming the second register of the memory controller to redefine the size of the buffer portion of the buffer/cache of the memory controller to be larger based at least in part on the number of commands using the buffer portion more than the cache portion.

17. The method of claim 15, wherein the number of commands include more write operations than read operations.

18. The method of claim 14, wherein the number of commands use the cache portion more than the buffer portion.

19. The method of claim 18, further comprising reprogramming the second register of the memory controller to redefine the size of the buffer portion of the buffer/cache of the memory controller to be smaller based at least in part on the number of commands using the cache portion more than the buffer portion.

20. The method of claim 19, wherein the number of commands include more read operations than write operations.
